(19) United States
(12) Patent Application Publication
(10) Pub. No.: US 2018/0099305 A1
(43) Pub. Date: Apr. 12, 2018

(54) LIQUID LEVEL CONTROL SYSTEM AND METHOD

(71) Applicant: MIRLE AUTOMATION CORPORATION, Hsinchu (TW)

(72) Inventors: Jung-Lung HUANG, HSINCHU (TW); Chin-Chang HUANG, HSINCHU (TW); Ying-Ju CHEN, HSINCHU (TW)

(21) Appl. No.: 15/396,335

(22) Filed: Dec. 30, 2016

(30) Foreign Application Priority Data
Oct. 11, 2016 (TW) 105132768

(51) Int. Cl. B05C 11/10; B05D 1/18; B05C 3/02; B05C 11/11

(52) U.S. Cl. CPC B05C 11/1026; B05C 11/11; B05C 3/02; B05D 1/18

(57) ABSTRACT

The present invention provides a liquid level control system and method. The present invention achieves a uniformly soaking process of a substrate during different segments of a fixed time period, by using a liquid removal device to gradually remove a processing liquid from a tank. The substrate is disposed in the liquid in the tank to be wet processed. By the removal of the liquid from the tank via the liquid removal device, an area of the portion of the substrate being processed by the liquid can be gradually decreased whereby the substrate can be uniformly processed.

### CROSS-REFERENCE TO RELATED APPLICATIONS

This application claims the benefits of Taiwan Patent Application No. 105132768 filed on Oct. 11, 2016, the contents of which are incorporated herein by reference in their entirety.

### FIELD OF THE INVENTION

The present invention relates to a liquid level control system and method, and more particularly to a liquid level control system and method which are suitable for wet processes, especially for the panel industry, the semiconductor industry and the bio industry.

### BACKGROUND OF THE INVENTION

In the panel industry, the wet process has developed to a pretty mature technology. However, there are many issues existing in real operation with the limit of the conventional mechanical design.

Please refer to FIG. 1, which depicts an illustrative drawing of a liquid level control system 10 of the conventional art. The control system includes a tank 11 and a mechanical clamping device 13. The tank 11 is used to store a liquid 12. Generally, the liquid 12 is a processing liquid, such as an etching solution and/or a bio solution. The mechanical clamping device 13 clamps a substrate 14 in the liquid 12 and motivates the substrate 12 to leave the liquid 12 slowly, thereby to achieve the purpose of uniformly wet processing the substrate 14 during different segments of a fixed time period. Generally, the substrate 14 is a glass panel or a wafer. In the conventional art, the mechanical clamping device 13 lifts the substrate 14 a predetermined distance at each time segment of the fixed time period. Generally, the mechanical actuation will not generate a bad influence to the substrate. However, vibration easily happens when the mechanical actuation moves the substrate for several micrometers per minute, whereby disturbance of a surface of the liquid is generated, correspondingly. A certain portion of the substrate 14, which has been processed and should not touch the liquid 12, might touch the liquid 12 again due to the vibration, making the final product of the substrate have defects.

Hence, it is needed to provide a liquid level control system to solve the technical issue as discussed above.

### SUMMARY OF THE INVENTION

One objective of the present invention is to provide a liquid level control system, which has an advantage for solving the above issue.

In order to achieve the objective, the present invention provides a liquid level control system, for a substrate wet-process, which includes a tank, a liquid, a fixing device, and a liquid removal device.

The liquid is stored in the tank. The fixing device is used to fix a substrate in the liquid. The liquid is used to perform processes on a portion of the substrate, which is soaked in the liquid. The liquid removal device is used to remove the liquid from the tank. The portion of the substrate soaked in the liquid is reduced when the liquid is gradually removed from the tank.

In one preferred embodiment, the liquid is selected from the group consisting of an etching solution and a bio solution.

In one preferred embodiment, the fixing device is disposed at a bottom of the tank.

In one preferred embodiment, the liquid removal device is selected from the group consisting of a micro valve and a dosing pump.

In one preferred embodiment, the liquid level control system further includes a filter, which is disposed at a position where the liquid enters into the liquid removal device.

In one preferred embodiment, the liquid level control system further includes a pipe, which is disposed at a position where the liquid leaves from the liquid removal device.

In one preferred embodiment, the liquid level control system further includes a negative pressure device, which is connected with the pipe.

In one preferred embodiment, the liquid removal device is a capillary unit, which removes the liquid from the tank based on capillary effect, with the touch of the capillary unit and the liquid.

In order to achieve the objective, the present invention further provides a liquid level control method, for a substrate wet-process, which includes:

A tank is disposed having a liquid stored therein.

A substrate is fixed by a fixing device in the liquid, wherein the liquid is used to perform processes to at least a portion of the substrate, which is soaked in the liquid.

The liquid is gradually removed from the tank by a liquid removal device, making the at least a portion of the substrate soaked in the liquid be reduced.

In one preferred embodiment, the liquid is selected from the group consisting of an etching solution and a bio solution.

In one preferred embodiment, the fixing device is disposed at a bottom of the tank.

In one preferred embodiment, the liquid removal device is selected from the group consisting a micro valve and a dosing pump.

In one preferred embodiment, the liquid removal device further includes a filter, which is disposed at a position where the liquid enters into the liquid removal device.

In one preferred embodiment, the liquid removal device further includes a pipe, which is disposed at a position where the liquid leaves from the liquid removal device.

In one preferred embodiment, the liquid level control method further includes a negative pressure device, which is connected with the pipe.

In one preferred embodiment, the liquid removal device is a capillary unit, which removes the liquid from the tank based on capillary effect, with the touch of the capillary unit and the liquid.

In comparison to the prior art, the present invention completely prevents technical issues of vibration along with mechanical actuation and disturbance of a surface of the liquid, by fixing the substrate at a certain distance from a bottom of the tank and gradually removing the liquid from the tank with the liquid removal device according to different requirements.

### BRIEF DESCRIPTION OF THE DRAWINGS

FIG. 1 depicts an illustrative drawing of a liquid level control system of the conventional art.

FIG. 2 depicts an illustrative drawing of a liquid level control system, for a substrate wet-process, according to one preferred embodiment of the present invention.

FIG. 3 depicts an illustrative drawing of a liquid level control system, for a substrate wet-process, according to another preferred embodiment of the present invention.

FIG. 4 depicts a flowchart of a liquid level control method, for a substrate wet-process, according to the present invention.

### DETAILED DESCRIPTION OF THE PREFERRED EMBODIMENTS

The advantages and features of the invention, as well as the method of carrying out these advantages and features, will become more apparent with the following detailed description of embodiments thereof with reference to the accompanying drawings. However, the present invention is not limited to the embodiments disclosed below, and the present invention can be implemented in a wide variety of different ways. The embodiments disclosed below are only intended to provide a more complete disclosure of the present invention. Those skilled in the art will be able to fully understand the scope of the invention, which is defined by the scope of the appended claims. Throughout the specification, the same reference numerals refer to the same elements.

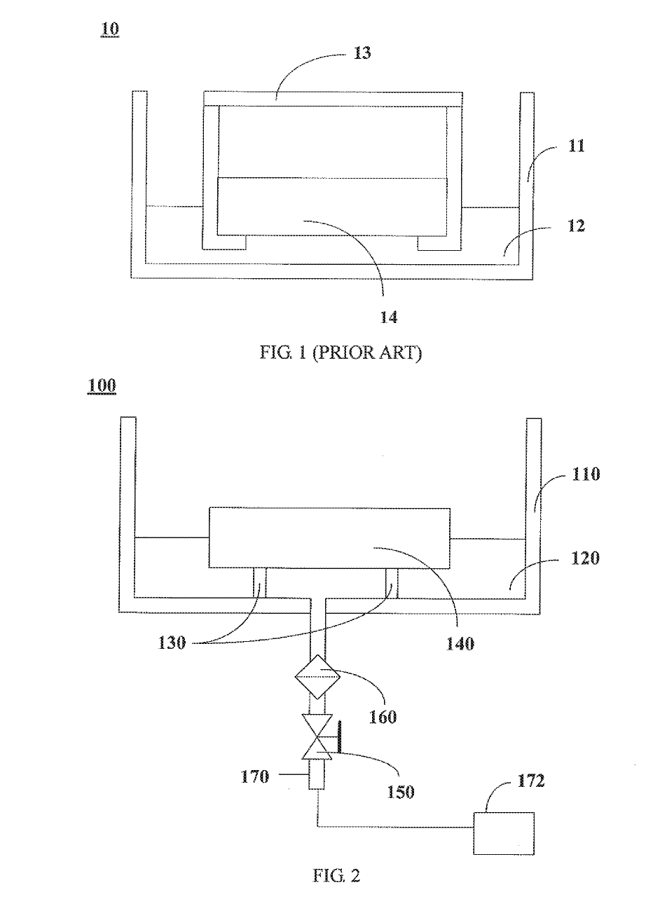

Please refer to FIG. 2, which depicts an illustrative drawing of a liquid level control system 100, for a substrate wet-process, according to one preferred embodiment of the present invention. The liquid level control system 100 includes a tank 110, a fixing device 130, and a liquid removal device 150. The liquid removal device 150 is a micro valve, and a filter 160 and a pipe 170 are disposed in FIG. 2, too. Alternatively, the liquid removal device 150 can be a micro valve or a dosing pump. The pipe 170 can connect to the air or a negative pressure device 172. In other preferred embodiments, it is fine that the filter 160, the pipe 170, and the negative pressure device 172 can be omitted, which are shown here for the preferred embodiment; however they are not absolutely required.

The tank 110 is used to store a liquid 120. Generally, the liquid 120 is a processing solution, such as etching solution and/or a bio solution, or other liquid might be used in a wet process. The fixing device 130 is used to fix a substrate 140 in the liquid 120. The liquid removal device 150 is used to remove the liquid 120 from the tank 110. Because in the panel industry or wafer industry, it is needed to perform a uniformly wet processing (soaking) process of the substrate 140 during different segments of a fixed time period, in short, making the portion of the substrate soaked in the liquid is reduced, gradually. The present invention abandons the conventional method of moving the substrate, with gradual removal of the liquid 120 from the tank 110, making the portion of the substrate 140 soaked in the liquid 120 is reduced, correspondingly. The removal speed can be timed and rationed and/or continuous, according to requirements.

In FIG. 1, the fixing device 130 is setup on a bottom of the tank 110. However, in other preferred embodiments, the fixing device 130 can possibly be setup at one of a side wall and an outside of the tank 110. Most importantly, the distance between the substrate 140 and the bottom of the tank 110 is fixed, and the uniformly soaking process of the substrate 140 during different segments of a fixed time period can be performed by changing the liquid level of the liquid 120.

Generally, the substrate 140 is a glass substrate or a wafer, so the substrate 140 can be sunken in the liquid 120.

In the preferred embodiment, the liquid 120 might generate etched precipitates or other impurities, so the filter 160 is disposed at a position before the liquid 120 enters into the liquid removal device 150. In other words, the filter 160 interconnects the tank 110 and the liquid removal device 150. Additionally, the liquid removing quantity setup by the liquid removal device 150 is very little, the liquid 120 might not be removed by vacuum or other issues, so the negative pressure device 172 is connected with the pipe 170, which is disposed at a position where the liquid 120 leaves from the liquid removal device 150, with applying a negative pressure to ensure that the liquid 120 can be continuously removed from the tank 110.

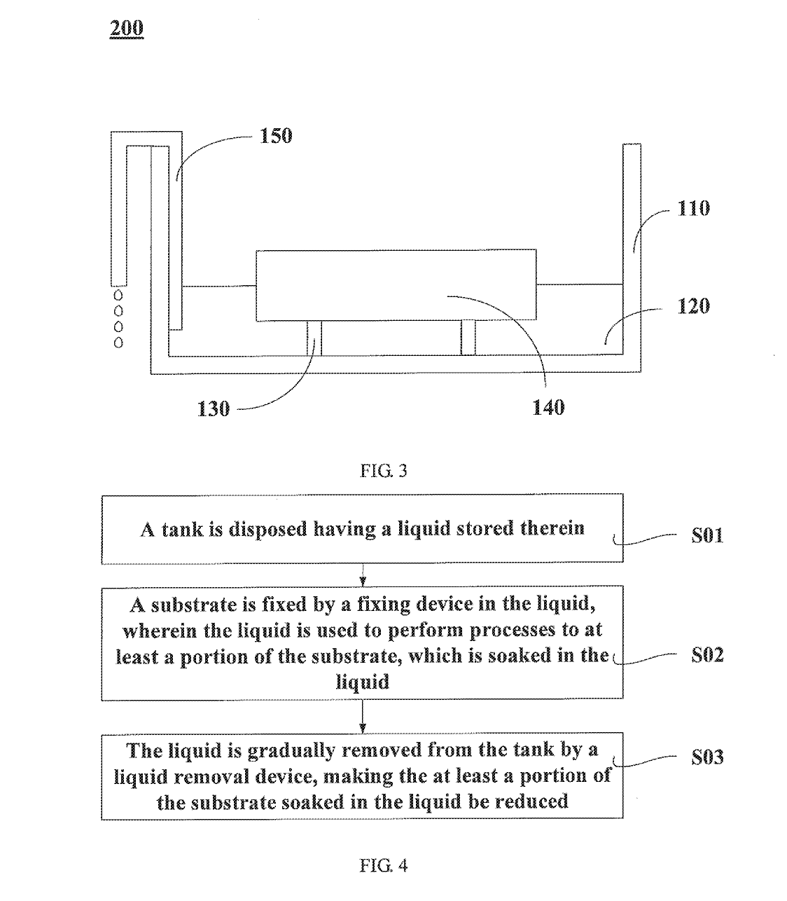

Please refer to FIG. 3, which depicts an illustrative drawing of a liquid level control system 200, for substrate wet-process, according to another preferred embodiment of the present invention. The difference between the another preferred embodiment and the above preferred embodiment is: the liquid removal device 150 is a capillary unit, which removes the liquid 120 from the tank 110 based on capillary effect, with the touch of the capillary unit and the liquid 120 by immersing the capillary unit into the liquid. The liquid 120 can flow along the removal device 150 to leave the tank 110 and the substrate 140.

Please refer to FIG. 4, which depicts a flowchart of a liquid level control method, for a substrate wet-process, according to the present invention. Please kindly refer to the above embodiments for the elements used in the method, which are not further addressed herein. The liquid level control method includes: Step S01, a tank 110 is disposed having a liquid 120 stored herein; Step S02, a substrate 140 is fixed by a fixing device 130 in the liquid 120, wherein the liquid is used to perform a wet processing process to at least a portion of the substrate, which is soaked in the liquid; step S03, the liquid 120 is gradually removed from the tank 110 by a liquid removal device 150, making the at least a portion of the substrate 140 soaked in the liquid 120 be reduced.

As mentioned above, the present invention completely prevents technical issues of abandoning the substrate for unevenly processed substrates, which are caused by vibration along with mechanical actuation and disturbance at a surface of the liquid, by fixing the substrate at a certain distance from a bottom of the tank and gradually removing the liquid from the tank with the liquid removal device according to different requirements.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structures.

What is claimed is:

1. A liquid level control system, for a substrate wet-process, comprising:
a tank;
a liquid stored in the tank;
a fixing device being used to fix a substrate in the liquid, wherein the liquid is used to perform processes to a portion of the substrate, which is soaked in the liquid; and
a liquid removal device being used to remove the liquid from the tank;
wherein the portion of the substrate soaked in the liquid is reduced when the liquid is gradually removed from the tank.

2. The liquid level control system of claim 1, wherein the liquid is selected from the group consisting of an etching solution and a bio solution.

3. The liquid level control system of claim 1, wherein the fixing device is disposed at a bottom of the tank.

4. The liquid level control system of claim 1, wherein the liquid removal device is selected from the group consisting a micro valve and a dosing pump.

5. The liquid level control system of claim 4, the liquid level control system further comprises a filter, which is disposed at a position where the liquid enters into the liquid removal device.

6. The liquid level control system of claim 5, wherein the liquid level control system further comprises a pipe, which is disposed at a position where the liquid leaves from the liquid removal device.

7. The liquid level control system of claim 6, wherein the liquid level control system further comprises a negative pressure device, which is connected with the pipe.

8. The liquid level control system of claim 1, wherein the liquid removal device is a capillary unit, which removes the liquid from the tank based on capillary effect, with the touch of the capillary unit and the liquid.

9. A liquid level control method, for a substrate wet-process, comprising:
disposing a tank having a liquid stored therein;
fixing a substrate in the liquid by a fixing device, wherein the liquid is used to perform processes to at least a portion of the substrate, which is soaked in the liquid; and
gradually removing the liquid from the tank by a liquid removal device, making the at least a portion of the substrate soaked in the liquid be reduced.

10. The liquid level control method of claim 9, wherein the liquid is selected from the group consisting of an etching solution and a bio solution.

11. The liquid level control method of claim 9, wherein the fixing device is disposed at a bottom of the tank.

12. The liquid level control method of claim 9, wherein the liquid removal device is one of a micro valve and a dosing pump.

13. The liquid level control method of claim 12, wherein the liquid removal device further comprises a filter, which is disposed at a position where the liquid enters into the liquid removal device.

14. The liquid level control method of claim 13, the liquid removal device further comprises a pipe, which is disposed at a position where the liquid leaves from the liquid removal device.

15. The liquid level control method of claim 14, wherein the liquid removal device further comprises a negative pressure device, which is connected with the pipe.

16. The liquid level control method of claim 9, wherein the liquid removal device is a capillary unit, which removes the liquid from the tank based on capillary effect, with the touch of the capillary unit and the liquid.
